(19) United States
(12) Patent Application Publication
(10) Pub. No.: US 2022/0389831 A1
(43) Pub. Date: Dec. 8, 2022

(54) REGULATING FLOW THROUGH A TURBO EXPANDER GENERATOR

(71) Applicant: Sapphire Technologies, Inc., Cerritos, CA (US)

(72) Inventors: Jeremy Liu, Cerritos, CA (US); Archie A.T. Andonian, Huntington Beach, CA (US); Freddie Sarhan, Cerritos, CA (US); John Stout, Long Beach, CA (US); James Ryan Yates, Cerritos, CA (US)

(21) Appl. No.: 17/342,202

(22) Filed: Jun. 8, 2021

(51) Int. Cl. F01D 17/16; F01D 25/16; F01D 15/10; F01D 17/24

(52) U.S. Cl. CPC F01D 17/165; F01D 25/16; F01D 15/10; F01D 17/24; F05D 2240/128; F05D 2240/51; F05D 2260/4031; F05D 2260/57

(57) ABSTRACT

An impeller is configured to be rotated by a flowing fluid. A fluid stator includes a fixed ring parallel to a plane of rotation of the impeller. The fixed ring has a center in-line with a center of rotation of the impeller. A rotatable ring is rotatable relative to, and parallel to, the fixed ring. The rotatable ring has a center in-line with a center of rotation of the impeller. Stator vanes extend between the fixed ring and the rotatable ring. The stator vanes define an inlet cross sectional area upstream of the impeller. The cross sectional area is dependent upon a relative position of the fixed ring and the rotatable ring. An actuator is configured to rotate the rotatable ring. An electric rotor is coupled to, and configured to rotate in unison with, the impeller. An electric stator encircles the electric rotor. The electric stator includes coil windings.

### TECHNICAL FIELD

The subject matter within this disclosure describes turbo expanders.

### BACKGROUND

In gas processing, liquefied and/or high pressure gas (e.g., hydrocarbons, hydrogen, or nitrogen) is depressurized prior to refining. To harness a pressure differential in the processing stream to generate power or electricity, a turbo expander can be used. A turbo expander includes an impeller that acts as a turbine. The turbo expander receives the gas and used the impeller to remove energy from the fluid (e.g., liquid, gas, or a combination) primarily in the form of pressure. In some instances, the turbo expander impeller acts as a driver for other processes. For example, the impeller can drive a pump, compressor, or generator.

### SUMMARY

This disclosure described technologies relating to regulating flow through turbo expanders.

An example implementation of the subject matter described within this disclosure is a turbo expander with the following features. An impeller is configured to be rotated by a flowing fluid. A fluid stator includes a fixed ring parallel to a plane of rotation of the impeller. The fixed ring has a center in-line with a center of rotation of the impeller. A rotatable ring is rotatable relative to, and parallel to, the fixed ring. The rotatable ring has a center in-line with a center of rotation of the impeller. Stator vanes extend between the fixed ring and the rotatable ring. The stator vanes define an inlet cross sectional area upstream of the impeller. The cross sectional area is dependent upon a relative position of the fixed ring and the rotatable ring. An actuator is configured to rotate the rotatable ring. An electric rotor is coupled to, and configured to rotate in unison with, the impeller. An electric stator encircles the electric rotor. The electric stator includes coil windings.

Aspects of the example turbo expander, which can be combined with the example turbo expander alone or in combination with other aspects, include the following. A gear train includes a rack and a pinion. The rotatable ring includes gear teeth to define the pinion. The actuator is coupled to the rack and configured to move the rack.

Aspects of the example turbo expander, which can be combined with the example turbo expander alone or in combination with other aspects, include the following. A gear train includes a worm gear and a pinion. The rotatable ring includes gear teeth to define the pinion. The actuator is coupled to the worm gear to rotate the worm gear.

Aspects of the example turbo expander, which can be combined with the example turbo expander alone or in combination with other aspects, include the following. A linkage includes a single pin coupled to the actuator and a slot defined by a portion of the rotatable ring. The slot receives the pin and to transfer movement from the pin to the rotatable ring.

Aspects of the example turbo expander, which can be combined with the example turbo expander alone or in combination with other aspects, include the following. A two-part linkage is connected by pins. The two-part linkage includes two arms translatable in a same plane connected by the pins. The two-part linkage provides sufficient coupling to transfer movement from the actuator to the rotatable ring. The two-part linkage provides adequate clearance to prevent binding of the linkage during actuation.

Aspects of the example turbo expander, which can be combined with the example turbo expander alone or in combination with other aspects, include the following. A linkage includes an extension fixed to the rotatable ring and a pin coupled to the actuator. The linkage is of an adequate length to prevent binding of the linkage during actuation.

Aspects of the example turbo expander, which can be combined with the example turbo expander alone or in combination with other aspects, include the following. The actuator is a linear actuator or a rotary motor.

Aspects of the example turbo expander, which can be combined with the example turbo expander alone or in combination with other aspects, include the following. Each and every stator vane is rotatably fixed to either the fixed ring or the rotatable ring.

Aspects of the example turbo expander, which can be combined with the example turbo expander alone or in combination with other aspects, include the following. Each and every stator vane is rotatable and slidably coupled to the other of the fixed ring or the rotatable ring that the each and every stator vane is not rotatably fixed.

Aspects of the example turbo expander, which can be combined with the example turbo expander alone or in combination with other aspects, include the following. Being slidably coupled includes slot and a pin retained within the slot.

Aspects of the example turbo expander, which can be combined with the example turbo expander alone or in combination with other aspects, include the following. The slot is defined by the each of the stator vanes.

Aspects of the example turbo expander, which can be combined with the example turbo expander alone or in combination with other aspects, include the following. The electric rotor and the impeller share a common, hermetically sealed housing that defines a flow path from an inlet at the turbo expander to an outlet downstream of the electric rotor.

Aspects of the example turbo expander, which can be combined with the example turbo expander alone or in combination with other aspects, include the following. An active magnetic bearing supports the impeller or the electric rotor.

An example implementation of the subject matter described within this disclosure is a method of controlling a turbo expander. The method includes the following features. An impeller wheel is rotated by a flowing fluid. An electric rotor is rotated by the rotating impeller. A flow condition of the fluid is adjusted by at least the following steps. A rotatable ring is rotated relative to a stationary ring. The rotatable ring is parallel to a fixed ring that is parallel to a plane of rotation of the rotating impeller. A cross sectional area of an inlet nozzle of the impeller is adjusted by stator vanes extending between the stationary ring and the rotatable ring.

Aspects of the example method, which can be combined with the example method alone or in combination with other aspects, include the following. The method of claim 14, further comprising generating electric current by an electric stator encircling the electric rotor responsive to rotating the electric rotor.

Aspects of the example method, which can be combined with the example method alone or in combination with other aspects, include the following. The electric rotor is supported by a magnetic bearing.

Aspects of the example method, which can be combined with the example method alone or in combination with other aspects, include the following. Rotating the rotatable ring includes rotating by a linear actuator.

Aspects of the example method, which can be combined with the example method alone or in combination with other aspects, include the following. Rotating the rotatable ring includes rotating by a rotational motor and a gear train.

Aspects of the example method, which can be combined with the example method alone or in combination with other aspects, include the following. The impeller is supported by an active magnetic bearing.

Aspects of the example method, which can be combined with the example method alone or in combination with other aspects, include the following. The flowing fluid includes a hydrocarbon gas expanded responsive to rotating the impeller.

An example implementation of the subject matter described within this disclosure is a turbo expander system with the following features. A turbo expander includes an impeller configured to be rotated by a flowing fluid. A fluid stator includes a fixed ring parallel to the impeller. The fixed ring has a center in-line with a center of rotation of the impeller. A rotatable ring is rotatable relative to, and parallel to, the fixed ring. The rotatable ring has a center in-line with a center of rotation of the impeller. Stator vanes extend between the fixed ring and the rotatable ring. The stator vanes define an inlet cross sectional area upstream of the impeller. An actuator is configured to rotate the rotatable ring. An electric rotor is coupled to, and configured to, rotate in unison with the impeller. An electric stator encircles the electric rotor. A controller is configured to control the turbo expander. The controller is separate from the turbo expander. A cable connects the controller to the turbo expander.

Aspects of the example turbo expander system, which can be combined with the example turbo expander system alone or in combination with other aspects, include the following. An active magnetic bearing supports the impeller or the electric rotor.

Aspects of the example turbo expander system, which can be combined with the example turbo expander system alone or in combination with other aspects, include the following. The cable includes a first conductor configured to filtered a pulse width modulated actuating signals to the active magnetic bearing. The first conductor is electrically shielded. A second conductor connects the controller to the active magnetic bearing. The second conductor is configured to exchange a DC current between the controller and the active magnetic bearing.

Aspects of the example turbo expander system, which can be combined with the example turbo expander system alone or in combination with other aspects, include the following. The first conductor and the second conductor are over 500 feet in length.

Aspects of the example turbo expander system, which can be combined with the example turbo expander system alone or in combination with other aspects, include the following. A hydrocarbon or process gas source feeds the turbo expander. The gas drives the impeller and is depressurized by the turbo expander.

The details of one or more implementations of the invention are set forth in the accompanying drawings and the description below. Other features, objects, and advantages of the subject matter described herein will be apparent from the description and drawings, and from the claims.

### DESCRIPTION OF DRAWINGS

FIG. 1 is a side, half cross sectional view of an example turbo expander.

FIGS. 2A-2C are planar views of an example stator that can be used with the example turbo expander.

FIGS. 3A-3C are planar views of an example stator that can be used with the example turbo expander.

FIG. 4 is a planar schematic diagram of various linkages that can be used to couple the stator to a linear actuator.

FIG. 5 is a planar view of an example stator, rotor, actuator, and linkage combination.

FIG. 6 is a block diagram of an example controller that can be used with aspects of this disclosure.

Like reference symbols in the various drawings indicate like elements.

### DETAILED DESCRIPTION

In gas processing, turbo expanders can be used to depressurize gas and/or liquefied natural gas, for example, where a processing plant receives hydrocarbon fluids from a pipeline or other transport. In some instances, for example, when hydrocarbon fluids are being processed at high pressures and/or extreme temperatures, the process fluids are hazardous if they come in direct contact with personnel. As turbo expanders include rotating components, dynamic seals, which are prone to failure, are relied upon to isolate personnel from hydrocarbons. In addition, turbo expanders are often “dumb”, passive pieces of equipment. That is, the turbo expander is often not a self-regulated piece of kit, relying instead upon surrounding processes to regulate flows and pressures through the turbo expander. For example, flow and pressure through a turbo expander can be regulated by a pressure regulator upstream or downstream of the turbo expander.

This disclosure describes a turbo expander with an adjustable stator that includes a fixed ring parallel to a plane of rotation of an impeller, and a rotatable ring rotatable relative to, and parallel to, the fixed ring. Stator vanes extend between the fixed ring and the rotatable ring. The stator vanes define an inlet cross sectional area upstream of the impeller. The cross sectional area is dependent upon a relative position of the fixed ring and the rotatable ring. The rotatable ring is adjusted and rotated by an actuator controlled by a controller. An electric rotor is coupled to, and is configured to rotate in unison with, the impeller. An electric stator encircles the electric rotor

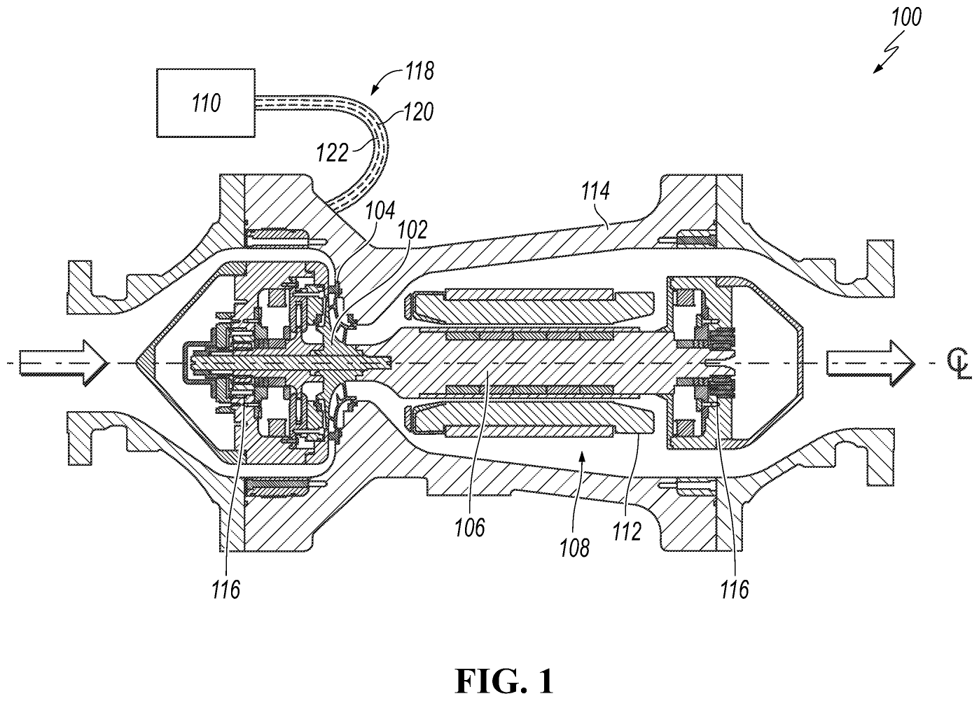

FIG. 1 is a side, half cross sectional view of an example turbo expander 100. The turbo expander 100 includes an impeller 102 configured to be rotated by a flowing fluid, such as a hydrocarbon source feeding the turbo expander 100. Such hydrocarbons are depressurized by the turbo expander 100, particularly by transferring energy to the rotating impeller 102. Surrounding the fluid impeller 102 is a fluid stator 104 configured to regulate a flow or velocity through the turbo expander 100. More details on the fluid stator 104 are described throughout this disclosure.

An electric rotor 106 is coupled to, and configured to rotate in unison with, the impeller 102. The electric rotor 106 can include an inductive rotor (e.g. squirrel cage or armature wound rotor), a permanent magnet rotor, a wound field synchronous rotor, or any other type of electric rotor. While illustrated and described as being directly coupled to rotate in unison, a gearbox and/or magnetic coupling can be used to couple the electric rotor 106 and the impeller 102 without departing from this disclosure. An electric stator 108 encircles the electric rotor 106. The electric stator 108 includes a coiled windings 112 through which electric current can flow. In operation, the field interaction between the electric rotor and the electric stator 108 can produce electric current and/or can be used to regulate a speed of an electric rotor 106, and therefore the impeller 102. For example, the electric rotor 106 and electric stator 108 can act as a generator, and an adjustable electric load can be used to regulate a rotational speed of the electric rotor. Such a variable load can be included with and/or controlled by a controller 110.

In some implementations, the electric rotor 106 and the impeller 102 share a common, hermetically sealed housing 114 that defines a flow path from an of the turbo expander 100 toward an outlet downstream of the electric rotor. In such implementations, an annulus, defined by an outer surface of the electric rotor 106 and an inner surface of the stator windings 112, exposed to the process fluid. In some implementations, a second annulus defined by an inner surface of a housing 114 and an outer surface of the stator can be similarly exposed to the process fluid. Regardless, such a hermetically sealed housing 114 arrangement reduces the risk of personnel exposure to the process fluid as eliminating dynamic seals eliminates them as a failure point as well.

In some implementations, the turbo expander 100 includes an active magnetic bearing 116 supporting the impeller 102 and/or the electric rotor 106. In such an implementation, the shaft of the electric rotor and/or impeller do not directly come in contact with a bearing surface attached to the housing 114. Such implementations can include active bearing control monitored and controlled by the controller 110. While primarily described and illustrated as using active magnetic bearings, other bearing types can be used without departing from this disclosure. For example, passive magnetic bearings can be used. Alternatively or in addition, anti-friction bearings can be used (e.g., ball bearings or roller bearings). Similarly, journal bearing can be used. In some implementations, types of bearings can be mixed, for example, an antifriction bearing and an active magnetic bearing can be used simultaneously.

In some implementations, the controller 110 can be located some distance from the turbo expander 100. For example, the controller can be 500 feet from the turbo expander, 1000 feet from the turbo expander, or 2000 feet from the turbo expander. The controller 110 is connected to the turbo expander by a cable 118. In some implementations, the cable 118 includes a first conductor 120 and a second conductor 122. The first conductor 120 is configured to filtered a pulse width modulated actuating signals to the active magnetic bearing 116. In some implementations, the first conductor is electrically shielded. The second conductor connects the controller to the active magnetic bearing 116. The second conductor 122 is configured to exchange a direct current between the controller 110 and the active magnetic bearing 116.

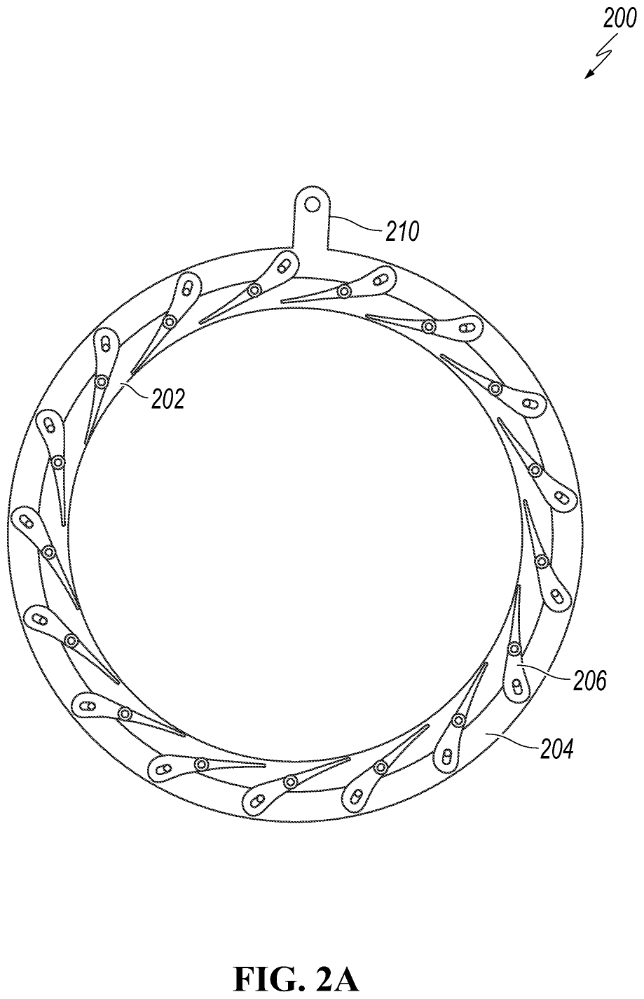

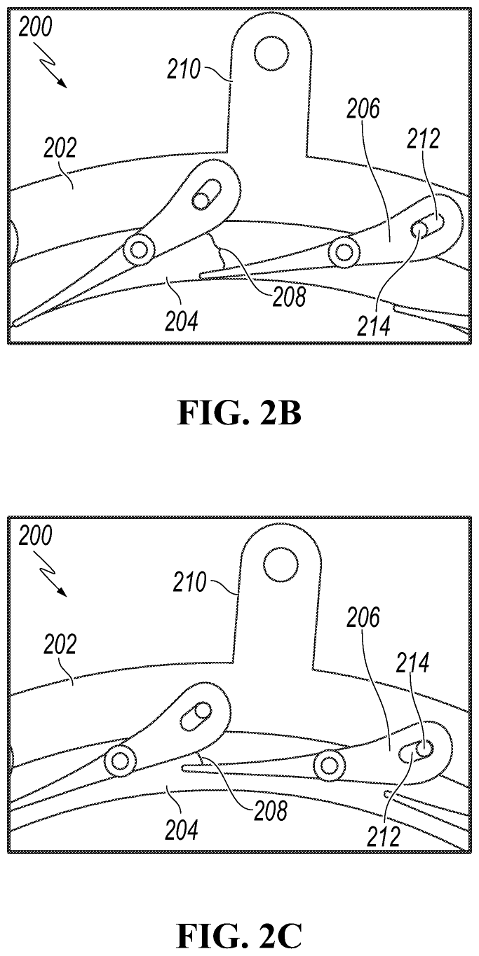

FIGS. 2A-2C are planar views of an example fluid stator 200 that can be used with the example turbo expander 100 and can be used in lieu of fluid stator 104 previously described. The stator includes two rings that encircle the impeller 102: a fixed ring 202 and a rotatable ring 204. Both the fixed ring 202 and the rotatable ring 204 are parallel to a plane of rotation of the impeller 102, and have a center that is in-line with a center of rotation of the impeller 102. The fixed ring 202 is stationary relative to the housing 114 (FIG. 1) while the rotatable ring 204 can rotate relative to the housing 114 and has the same axis of rotation as the impeller 102.

Multiple stator vanes 206 extend between the fixed ring 202 and the rotatable ring 204. The stator vanes 206 define an inlet cross sectional area upstream of the impeller 102. In the illustrated implementations, the flow goes from the outside radius of the impeller 102 towards a center of the impeller 102; however, other arrangements are feasible without departing from this disclosure. For example, the flow direction can be from the center of the impeller to the outer radius of the impeller while the stator vanes define an outlet cross sectional area downstream (outlet) of the impeller 102. Regardless of the arrangement, the cross sectional area is dependent upon a relative position of the fixed ring 202 and the rotatable ring 204. That is, the rotational position of the rotatable ring 204 determines the cross sectional flow area 208. In some implementations, the rotatable ring can include an extension or tab 210 to be coupled to an actuator and/or linkage such that the actuator is configured to rotate the rotatable ring 204 to a desired position, setting a flowrate through the turbo expander 100;

Each and every one of stator vanes 206 is rotatably fixed to either the fixed ring 202 or the rotatable ring 204. That is, each of the stator vanes is coupled to one of the rings such that the vane is capable of pivoting around a fixed point of that ring without being able to translate. In the illustrated implementation, the vanes 206 are rotably fixed to the fixed ring 202; however, the vanes 206 could be similarly fixed to the rotatable ring 204 without departing from this disclosure.

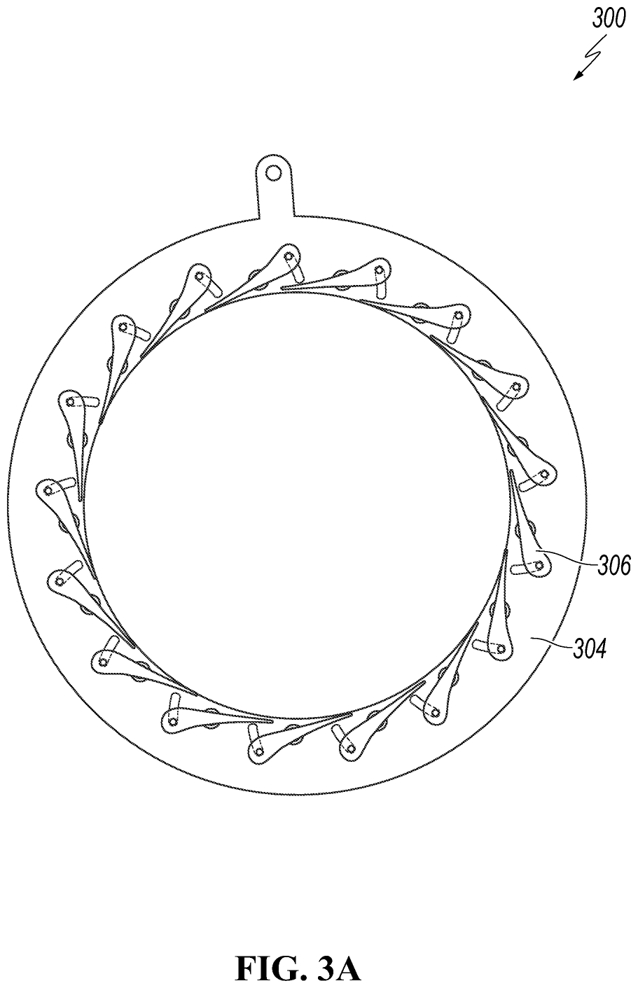

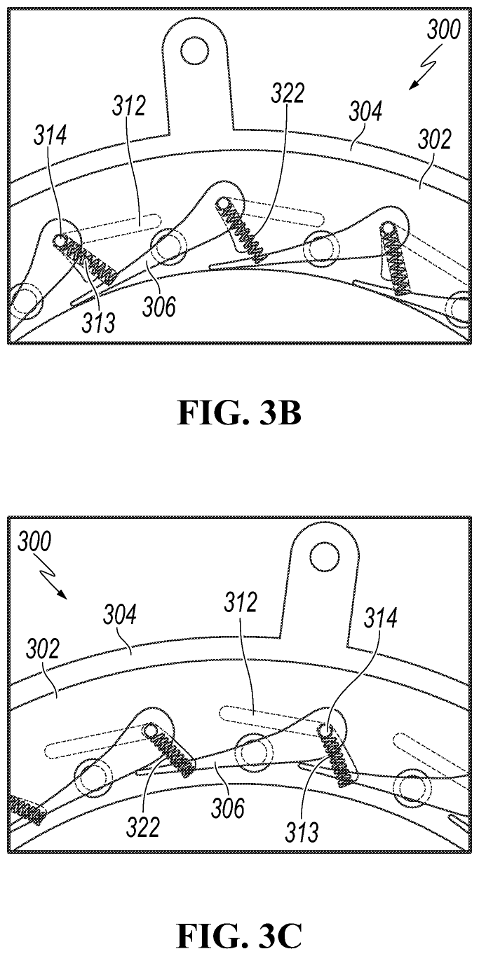

Each and every one of stator vanes 206 are also rotatable and slidably coupled to the other of the fixed ring or the rotatable ring that the each and every stator vane is not rotatably fixed. In other words, each of the stator vanes 206 includes a pivot point coupled to one of the rings (202 or 204) and a pivotable/translatable connection coupled to the other ring. In some implementations, being slidably coupled can include a slot 212 and a pin 214 retained within the slot 212. In such implementations, the slot can defined by the each of the stator vanes, or each slot can be defined by a ring, as illustrated in FIGS. 3A-3B.

FIGS. 3A-3C are planar views of an example fluid stator 300 that can be used with the example turbo expander 100. The example fluid stator 300 is substantially similar to fluid stator 200 previously described except for any differences described herein. The stator vanes 306 can include a pivot point coupled to the rotatable ring 304. In some implementations, the rotatable ring 304 and/or the fixed ring 302 define slots 312 and 313. The intersection of the two slots determines the position of the pins 314 and the angular position of the stator vanes 306. On the rotatable ring 304 the slots allow for rotation around the pivot point. The rotatable ring 304 is stacked upon the fixed ring 302. That is, the rotatable ring 304 is positioned between the fixed ring and the stator vanes 306. Other arrangements can be used without departing from this disclosure. In some implementations, the stator vanes and/or rings can include a bias, for example, a spring 322, to default the stator vanes 306 into a default position in the case of an actuator and/or linkage failure.

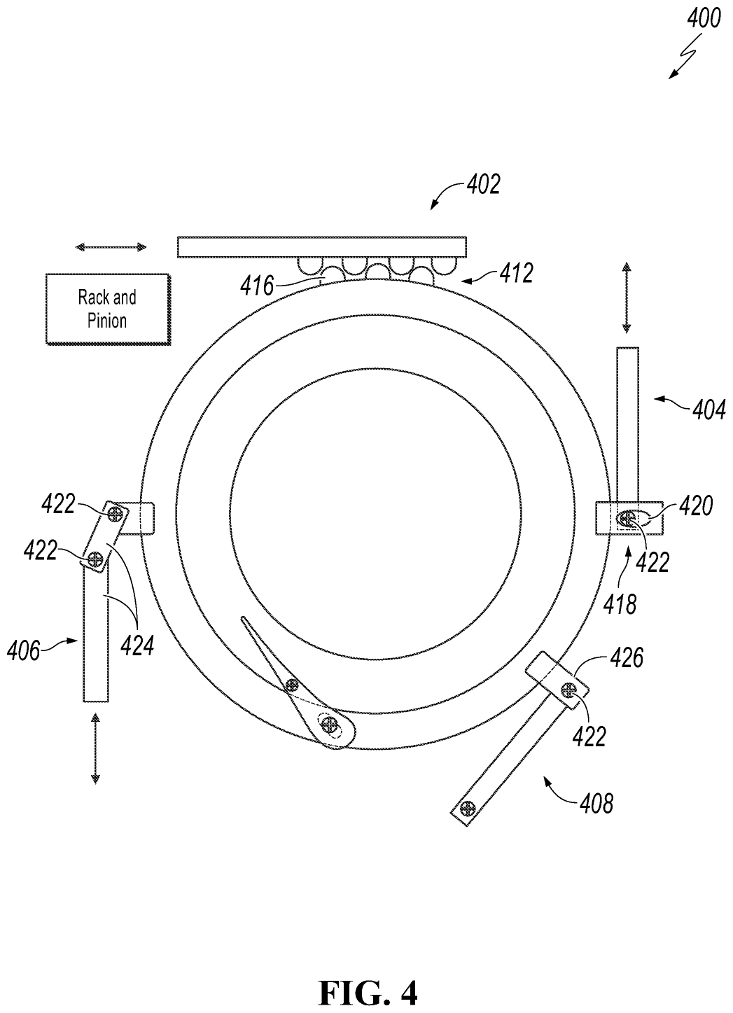

FIG. 4 is a planar schematic diagram of various linkages (402, 404, 406, and 408) that can be used to couple the stator 400 to a linear actuator. Each of the illustrated and described linkages can be used by itself, or in combination with any other linkages described within this disclosure. Each of the linkages described herein can be used in conjunction with any of the fluid stator described throughout this disclosure.

The first linkage 402 is a gear train that includes a rack 410 and a pinion 412. In such an implementation, the rotatable ring 414 includes gear teeth 416 to define the pinion 412. A linear actuator (not shown) is coupled to the rack 410 and is configured to linearly move the rack 410. This implementation can be made to allow for a large degree of movement between a fully open position of the stator vanes 206 and a fully closed position of the stator vanes 206. A wider operational range can be useful in plants that experience large variations in hydrocarbon flowrates. This implementation can be driven by a motor, rotating actuator, or other drive arrangement.

The second linkage 404 includes a single pin coupled to an actuator, and a slot 420 defined by a portion of the rotatable ring 414, for example, a tab 418. The slot 420 receives the pin 422 and to transfer movement from the pin 422 to the rotatable ring 414. The slot 420 allows for the linear movement of the actuator to be continuously transferred to the circular rotatable ring 414 without creating a significant force moment (greater than that caused by misalignments inherent in standard manufacturing environments) on the actuator. Such an implementation is relatively easy to manufacture. This implementation can be driven by linear actuators, or other drive arrangements.

The third linkage is a two-part linkage 406 connected by pins 422. The two-part linkage 406 includes two arms 424 translatable in a same plane connected by the pins 422. The two-part linkage provides sufficient coupling to transfer movement from the actuator to the rotatable ring. That is, the two-part linkage 406 provides adequate clearance to prevent binding of the linkage 406 during actuation. Such an implementation accomplishes such a feat by allowing for the linear movement of the actuator to be continuously transferred to the circular rotatable ring 414 without creating a significant force moment (greater than that caused by misalignments inherent in standard manufacturing environments) on the actuator. Such an implementation is relatively easy to manufacture, and allows for a greater range of motion than the linkage 404 previously described.

The fourth linkage 408 is an extension 426 fixed to the rotatable ring 414, and a pin 422 coupled to the actuator. The linkage 408 is of an adequate length to prevent binding of the linkage during actuation. In such implementations, a moment is present on the actuator and/or linkage as the linear motion is coupled to a rotational movement. Such a moment can be mitigated by flexing of the linkage 408, or by adding an additional pin 422 to the actuator itself.

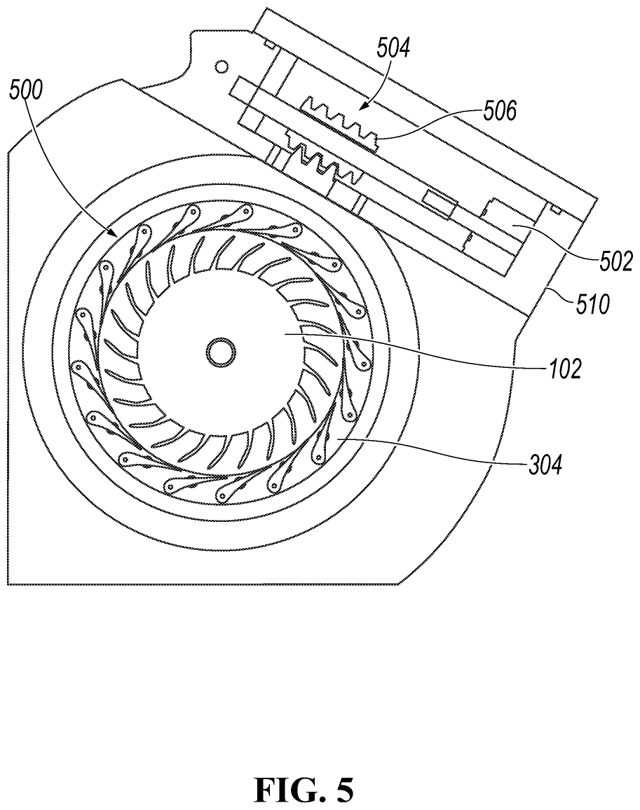

FIG. 5 is a planar view of an example fluid stator 500, impeller 102, actuator 502, and linkage 504 combination. The fluid stator 500, the impeller 102, actuator 502, and linkage 504 are substantially similar to implementations previously described with the exception of any differences described herein. While primarily described as using a linear actuator, a rotary motor (actuator 502) can also be used to adjust the rotatable ring 304. In such implementations, the linkage can include a worm gear 506 directly rotated by the rotary motor (actuator 502). The worm gear 506 meshes with corresponding teeth coupled to and/or defined by the rotatable ring 304 such that the rotatable ring 304 acts as a pinion.

In some implementations, the entire actuator (for example, the rotary motor 502) can be completely encased within the hermetically sealed housing 510. In some implementations, the actuator can be positioned on the outside of the housing, and various sealing elements can be used to isolate the actuator from the process fluid. For example, such sealing elements can include dynamic seals that contact the linkage.

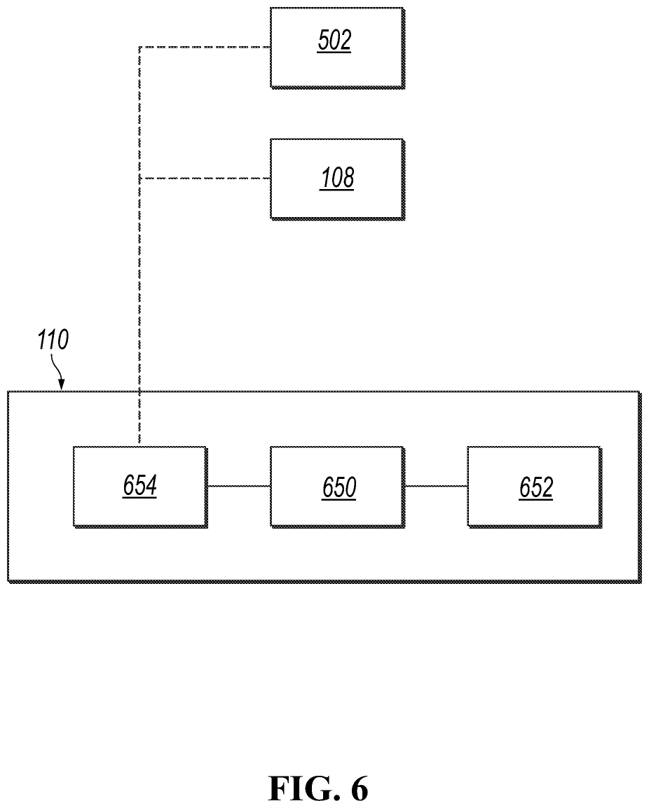

FIG. 6 is a block diagram of an example controller 110 that can be used with aspects of this disclosure. The controller 110 can, among other things, monitor parameters of turbo expander 100 and send signals to actuate and/or adjust various operating parameters of the turbo expander 100. As shown in FIG. 6, the controller 110, in certain instances, includes a processor 650 (e.g., implemented as one processor or multiple processors) and a non-transitory memory 652 (e.g., implemented as one memory or multiple memories) containing instructions that cause the processors 650 to perform operations described herein. The processors 650 are coupled to an input/output (I/O) interface 654 for sending and receiving communications with components in the system, including, for example, the fluid stator, the electric stator 108, or the magnetic bearing 116. In certain instances, the controller 110 can additionally communicate status with and send actuation and/or control signals to one or more of the various system components (including an actuator system) of the turbo expander 100, as well as other sensors (for example, a pressure sensor, a shaft position sensor, and other types of sensors) provided in the turbo expander 100. In certain instances, the controller 110 can communicate status and send actuation and control signals to one or more of the components within the turbo expander 100, such as the actuator 502 or the magnetic bearing 116. The communications can be hard-wired, wireless, or a combination of wired and wireless. In some implementations, controllers similar to the controller 110 can be located elsewhere, such as in a control room, elsewhere on a site, or even remote from the site. For example, the controller, in some implementations, can be 500 feet from the turbo expander, 1000 feet from the turbo expander, or 2000 feet from the turbo expander. In some implementations, the controller 110 can be a distributed controller with different portions located around an operation site, such as a gas plant. Additional controllers can be used throughout the site as stand-alone controllers or networked controllers without departing from this disclosure.

In operation, the turbo expander works as follows. Some or all of the steps described within this disclosure can be performed by the controller 110. Hydrocarbon gas (or other high pressure gasses) are fed into the inlet of the turbo expander 100, rotating an impeller wheel by the fluid flow. Responsive to rotating the impeller the flowing fluid is expanded. That is, the pressure of the fluid is decreased. The rotating impeller 102 further rotates the electric rotor 106. Responsive to rotating the electric rotor, electric current is generated by the electric stator 108 encircling the electric rotor 106. In some implementations, the electric rotor and/or the impeller are supported by a magnetic bearing. Such a magnetic bearing can be a passive magnetic bearing or an active magnetic bearing.

To maintain a desired feed rate of fluid, a flow-rate of the fluid can be adjusted by adjusting a cross sectional area of an inlet nozzle (fluid stator) of the impeller 102 by a set of stator vanes extending between the stationary ring and the rotatable ring. Adjusting the stator vanes involves rotating the rotatable ring relative to the stationary ring. The rotatable ring can be rotated by an actuator connected to the rotatable ring by a linkage and/or gear train.

A number of implementations of the invention have been described. Nevertheless, it will be understood that various modifications may be made without departing from the spirit and scope of the invention. For example, a cross sectional area of an outlet or a turbo expander can be adjusted without departing from this disclosure. Accordingly, other implementations are within the scope of the following claims.

1. A turbo expander comprising:
a hermetically sealed housing defining an inlet and an outlet;
an impeller configured to be rotated by a flowing fluid flowing from the inlet to the outlet;
a fluid stator between the inlet and the impeller, the fluid stator comprising:
a fixed ring parallel to a plane of rotation of the impeller, the fixed ring having a center in-line with a center of rotation of the impeller;
a rotatable ring rotatable relative to, and parallel to, the fixed ring, the rotatable ring having a center in-line with a center of rotation of the impeller; and
a plurality of stator vanes extending between the fixed ring and the rotatable ring, the plurality of stator vanes defining an inlet cross sectional area upstream of the impeller, the cross sectional area being dependent upon a relative position of the fixed ring and the rotatable ring; and
an actuator configured to rotate the rotatable ring;
an electric rotor between the fluid stator and the outlet, the electric rotor coupled to the impeller and configured to rotate in unison with the impeller;
an electric stator encircling the electric rotor, the electric stator comprising coil windings; and
the hermetically sealed housing encompassing the fixed ring, the rotatable ring, the plurality of stator vanes, the electric rotor, and the electric stator.

2. The turbo expander of claim 1, further comprising a gear train that comprises a rack and a pinion, wherein the rotatable ring comprises gear teeth to define the pinion, the actuator being coupled to the rack and configured to move the rack.

3. The turbo expander of claim 1, further comprises a gear train that comprises a worm gear and a pinion, wherein the rotatable ring comprises gear teeth to define the pinion, the actuator being coupled to the worm gear to rotate the worm gear.

4. The turbo expander of claim 3, further comprising a linkage comprising a single pin coupled to the actuator, and a slot defined by a portion of the rotatable ring, the slot receiving the pin and to transfer movement from the pin to the rotatable ring.

5. The turbo expander of claim 3, further comprising a two-part linkage connected by pins, the two-part linkage including two arms translatable in a same plane connected by the pins, the two-part linkage providing sufficient coupling to transfer movement from the actuator to the rotatable ring, the two-part linkage providing adequate clearance to prevent binding of the linkage during actuation.

6. The turbo expander of claim 3, further comprising a linkage comprising an extension fixed to the rotatable ring, and a pin coupled to the actuator, the linkage being of an adequate length to prevent binding of the linkage during actuation.

7. The turbo expander of claim 1, wherein the actuator is a linear actuator or a rotary motor.

8. The turbo expander of claim 1, wherein each and every of the plurality of stator vanes is rotatably fixed to either the fixed ring or the rotatable ring.

9. The turbo expander of claim 8, wherein each and every of the plurality of stator vanes are rotatable and slidably coupled to the other of the fixed ring or the rotatable ring that the each and every of the plurality of stator vanes are not rotatably fixed.

10. The turbo expander of claim 9, wherein being slidably coupled comprises slot and a pin retained within the slot.

11. The turbo expander of claim 10, wherein the slot is defined by the each of the plurality of stator vanes.

12. (canceled)

13. The turbo expander of claim 1, further comprising an active magnetic bearing supporting the impeller or the electric rotor.

14-25. (canceled)

26. The turbo expander of claim 10, wherein the slot is defined by the fixed ring or the rotatable ring.

27. The turbo expander of claim 1, wherein the electric rotor is a permanent magnet rotor.

28. The turbo expander of claim 1, comprising an actuator outside of the hermetic housing.

29. The turbo expander of claim 1, where the electric rotor and the electric stator define an annulus therebetween, and where the turbo expander is configured to flow at least a portion of the fluid flowing from the inlet to the outlet through the annulus.

30. The turboexpander of claim 29, where the electric stator and the hermetically sealed housing define a second annulus therebetween, and where the turbo expander is configured flow at least a portion of the fluid flowing from the inlet to the outlet through the second annulus.

31. The turbo expander of claim 1, where the electric stator and electric rotor are exposed to the fluid flowing from the inlet to the outlet.

32. The turbo expander of claim 1, where the fluid stator resides immediately adjacent the impeller.

33. The turbo expander of claim 1, where the fluid stator encircles the periphery of the impeller.

34. The turbo expander of claim 1, where the electric rotor and the electric stator are downstream of the impeller in the fluid flowing from the inlet to the outlet.
